(19) United States
(12) Patent Application Publication
(10) Pub. No.: US 2015/0003834 A1
(43) Pub. Date: Jan. 1, 2015

(54) Brillouin Strain and Temperature sensor incorporating a frequency offset locked DFB laser pair

(71) Applicants: Xuekang SHAN, San Diego, CA (US); Jin HAO, San Diego, CA (US); Runbao HAO, Jin Zhong (CN)

(72) Inventors: Xuekang SHAN, San Diego, CA (US); Jin HAO, San Diego, CA (US); Runbao HAO, Jin Zhong (CN)

(21) Appl. No.: 13/932,005

(22) Filed: Jul. 1, 2013

(51) Int. Cl. H04B 10/2575

(52) U.S. Cl. CPC H04B 10/2575
USPC 398/116

(57) ABSTRACT

A distributed fiber sensor system based on Brillouin scattering. Two DFB lasers are included that are frequency offset locked to each other. The frequency offset is approximately equal to the Brillouin shift in optical fibers of about 11 GHz. The locking is realized by first modulating the output of one DFB laser with an electro-optic modulator to generates side bands that are about 11 GHz from the carrier, and then by locking the other DFB laser to the upper side band with a PID controller which controls its driving current.

References cited: U.S. Pat. No. 7,499,151 March 2009 X. Bao et al.

### BACKGROUND OF THE INVENTION

Fiber optic distributed sensors based on Brillouin scattering have been the subject for research and development for the past two decades. Brillouin scattering in optical fibers is the interaction of light with acoustic phonons propagating in the fiber core, and the scattered Brillouin signal travels backwards in relationship with the launched optical power. The Brillouin scattering light has a frequency shift from the original light, which is proportional to the local velocity of the acoustic phonon. This velocity depends on the material density and tension of the fiber core and thus on the local temperature and strain, as is shown in FIG. 1. The Brillouin frequency shift ν_{B} in silica single mode optical fibers is around 11 GHz. If the original light has a frequency ν₀, the Brillouin scattered light will have a frequency of ν₀-ν_{B}. ν_{B} Changes with local fiber temperature and strain. To measure changes in ν_{B}, the original optical signal is first to undergo a frequency up shift which is approximately equal to ν_{B}. Then, when the back Brillouin scattered light is mixed with the original light, the beat signal is a low frequency signal for easy detection.

A key technology in Brillouin distributed sensors is the optical signal frequency shifting, which ensures that one optical signal has a frequency higher than that of another by the amount of the Brillouin frequency shift (˜11 GHz) in optical fibers. The most common means is to use an acousto-optic modulator (AOM) which is placed in an optical loop. Every time an optical pulse passes though the AOM, it experiences a frequency up shift Δν, which is typically 30-50 MHz. After traveling many times in the loop, the pulse's optical frequency is up shifted by approximately 11 GHz and is then launched into the sensing fiber. However, this method suffers from two drawbacks.

First, the optical loop containing the AOM has attenuation of a few dB per loop travel. After traveling hundreds of times in the loop, the pulse energy is seriously attenuated. Although optical amplifiers such as EDFA can be used to boost the signal, the signal to noise ratio is inevitably reduced, since all optical amplifiers have spontaneous emission which is added to the amplified signal in the form of noise.

Second, the frequency is up shifted in step size of a few tens of MHz, not any smaller. However, it is desirous that the probe's optical frequency can be tuned in much smaller step sizes over the entire Brillouin bandwidth.

Another approach uses a Brillouin fiber laser to realize the optical frequency shift. A DFB laser with an optical frequency of ν₀ is used as the pump for the fiber laser which generates an output at an optical frequency of ν₀-ν_{B} through Stimulated Brillouin Scattering in the fiber cavity. The problem in this scheme is that it is difficult to make a CW Brillouin fiber laser with long term stability.

There are also techniques that utilize electro optic modulators to generate carrier suppressed single side band optical signal. The driving signal applied to the modulator has a frequency equal to the Brillouin shift, and the optical side band is at the desired optical frequency in respect to the original optical signal. However, the suppression of the carrier is limited to about 37 dB. The leaked carrier will lead to the degradation of signal to noise ratio of the Brillouin signal, because the leaked carrier will generate Rayleigh scattering, which is about 20 dB stronger than Brillouin scattering at equal input power, and thus generates noise in the optical receiver.

Recently, a prior art proposed the use of two DFB lasers Brillouin frequency offset locked to each other. The locking was realized by first combining the two DFBs' output. Then split the combined output into two paths, which are sent to two photodiodes. The outputs of the photodiodes are sent to a mixer. An optical delay line is inserted in one path to produce the relative frequency tuning of the two DFB lasers around the Brillouin frequency shift in optical fibers. The speed of the sensor system is thus limited by the delay line scan rate.

This invention describes a Brillouin distributed sensor in which two DFB lasers are frequency offset locked to each other to work as the pump and the probe, respectively. This locking scheme provides high optical spectrum purity and fast frequency tuning.

### SUMMARY

The present invention relates to a distributed fiber sensor based on Brillouin scattering. Two DFB lasers are frequency offset locked to each other, the frequency difference being the Brillouin shift in sensing optical fiber. This is realized by modulating one of the two DFB lasers with an electro-optic modulator to generate optical side bands and by locking the other DFB laser to one of the side bands. Each DFB laser has a tap coupler for tapping a few percent of its output power to a fiber coupler, which combines the two outputs and feeds them to a photodiode. In the photodiode the beat frequency between the two DFB lasers is generated, and is fed to a frequency discriminator. The frequency discriminator converts the beat frequency into a proportional voltage. A PID controller uses this voltage as the error signal to control the driving current of one of the DFB lasers to keep the error signal at its possible minimum. The DFB laser with lower optical frequency works as the CW probe in the Brillouin distributed sensor. The other DFB laser, whose optical frequency is higher by the amount of Brillouin frequency shift in sensing optical fiber, is pulse modulated and power amplified. This laser works as the pulsed pump in the sensor system. The CW probe enters a length of sensing fiber from one end, and the pulse pump form the other end. The intense pump pulse interacts with the counter propagating CW probe through Stimulated Brillouin Scattering, and the Brillouin signal containing strain and temperature information along the sensing fiber is detected by a photodiode and converted into electric signal for processing by a computer.

### BRIEF DESCRIPTION OF THE DRAWINGS

FIG. 1 shows the Brillouin frequency shift in an optical fiber.

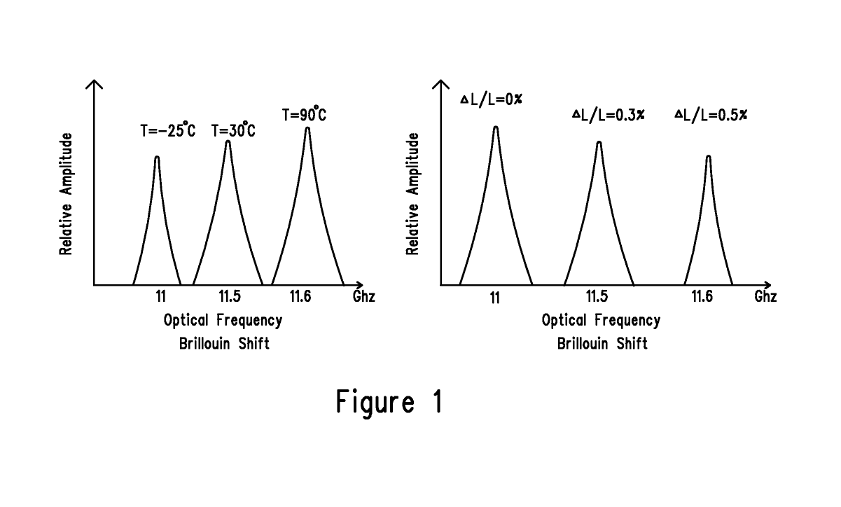

FIG. 2 shows the modulation side bands.

FIG. 3 shows the details of frequency offset locking of two DFB lasers with side band generation.

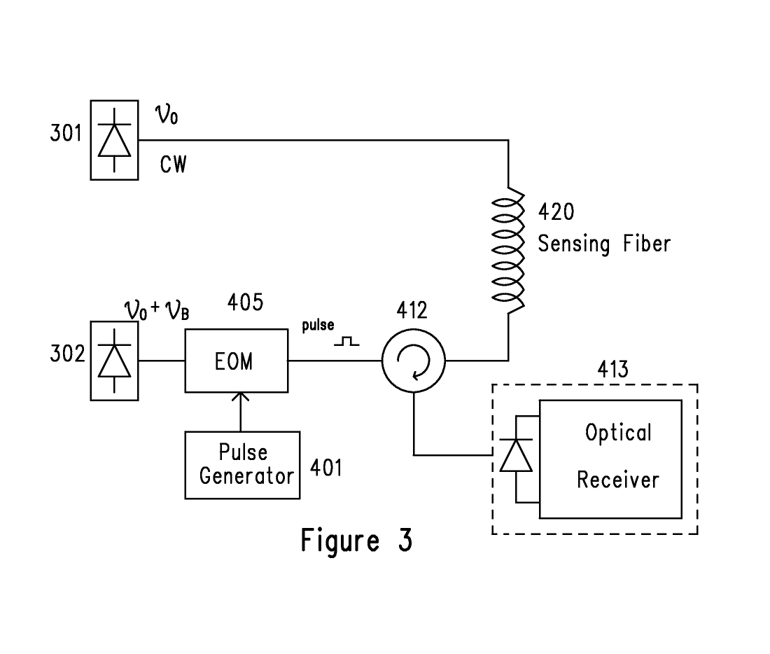

FIG. 4 shows the setup of the Brillouin distributed fiber sensor.

### DETAILED DESCRIPTION OF THE PREFERRED EMBODIMENT

This invention relates to a method of frequency offset locking of two DFB lasers by means of locking to an optical side band generated by modulation for application in Brillouin scattering distributed sensors.

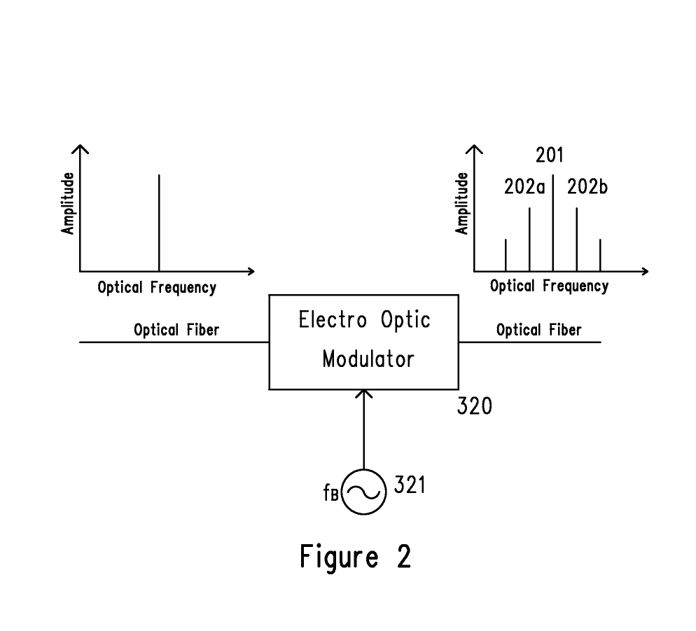

DFB laser A 301's output is split into two paths by a polarization maintaining (PM) optical tap coupler 310. One path goes to an electro-optic modulator 320, which can be either an amplitude or a phase modulator, and which is driven by an electric signal 321. As is well known in optical communications theory, amplitude or phase modulation generates optical side bands, as is shown in FIG. 2. The spacing between side the first order bands 202a, 202b, and the carrier 201 is equal to the frequency of the driving electric signal 321. DFB laser B 302's output is also split into two paths by a polarization maintaining (PM) optical tap coupler 311. One path is combined with the modulator's output by a polarization maintaining (PM) 50:50 optical coupler 312 and sent to a photodiode 303. The photodiode outputs the beat signal between the two optical signals. A PID controller 304 controls DFB laser B's driving current to keep it frequency locked to the first order side band of the modulator output. Since it is easy and fast to tune the frequency of an electric signal, it is easy and fast to sweep the optical probe's frequency over the entire Brillouin spectrum. This is important when Stimulated Brillouin Scattering (SBS) gain is used to extend the sensor's working distance. To measure the Brillouin gain profile, the frequency difference between the pump and the probe must be swept over the entire Brillouin gain band.

Because there could be a number of side bands plus the carrier in the output of the modulator, it is important to make sure that DFB laser B 302 is locked to the correct side band 202b. This is realized by first stabilizing the frequency (wavelength) of DFB laser A, and by controlling the modulation depth such that the carrier's amplitude is considerably higher than any side bands. Then the wavelength of DFB laser B 302 is swept through the side bands of DFB A to locate the highest peak which is the carrier 201, and then the controller locks DFB B to the first side band 202b.

In detail, the frequency locking is realized by controlling the driving current of DFB laser B 302. DFA laser B is first set to an appropriate operating temperature by a temperature controller (TC). The output of the photodiode, which is the beat frequency, is sent to a frequency discriminator 305 that converts frequency into a proportional voltage, and this voltage is used as the error signal for the controller 304. A proportional integral derivative (PID) logarithm measures the error signal and varies DFB laser B's current through a current source (CS) accordingly to keep the error signal at its possible minimum. With a properly designed PID controller, the beat frequency can be controlled to be below 100 kHz. This sets the ultimate resolution of the sensor, which corresponds to 0.0002% for strain or 0.1° C. for temperature.

Compared to the prior art, the present invention provides fast frequency tuning, time and temperature stability, optical spectrum purity, and low cost. Fast tuning and stability is intrinsically guaranteed by the electric signal generator which drives the electro optic modulator. DFB lasers readily achieve more than 50 dB side band suppression. Components such as electro optic modulators, DFB lasers, and PM fiber couplers have seen steady price reduction in the past few decades.

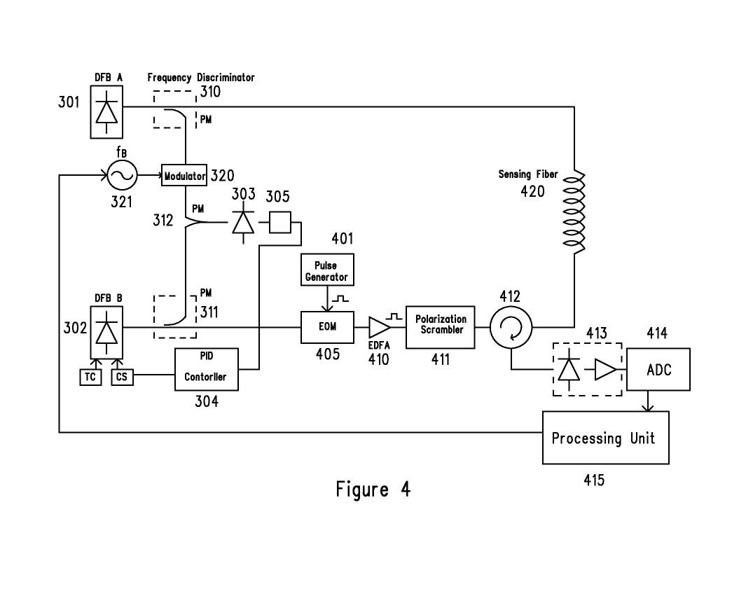

FIG. 4 shows two DFB lasers frequency offset locked used as the probe and pump respectively in a Brillouin Optical Domain Analyzer (BOTDA).

DFB laser A emits with frequency ν₀, and DFB laser B emits with frequency ν₀+ν_{B}. DFB laser A works as the CW probe in the sensor system. The CW output of DFB laser B is pulse modulated by an electro-optic modulator (EOM) 405 and then boosted in power by an EDFA 410. A polarization scrambler 304 is inserted between the EDFA and the optical circulator 412 to eliminate instability caused by random polarization effects in the fibers. The high power optical pulse acts as the pump in the sensor system. In the sensing fiber 420, which is ordinary communications single mode fiber, the intense pump pulse interacts through Stimulated Brillouin Scattering (SBS) with the counter propagating weak CW probe and amplifies it. The frequency offset between the pump and the probe is controlled by the computer to scan step by step across the whole Brillouin gain band. The optical signal containing the information of strain/temperature in the sensing fiber goes through an optical circulator 412 and is detected by the optical receiver 413 which converts it into an electrical signal. This electrical signal is then converted into digital format by an ADC 414 and is processed by the processing unit 415 to generate the sensor output.

What is claimed is:

1. A fiber optic Brillouin distributed sensor comprising:
a. Two distributed feedback (DFB) lasers;
b. An electro-optic modulator;
c. An electrical signal generator;
d. An optical fiber coupler that combines two optical signals into one output;
e. A photodiode that mixes the two optical signals from the optical fiber coupler, and that outputs the beat frequency of the two optical signals;
f. A frequency discriminator that converts frequency into a proportional voltage;
g. A proportional integral derivative (PID) controller to control the driving current of one of the two DFB lasers;
h. A length of sensing fiber;
i. An optical circulator;
j. An optical receiver;
k. A computer for signal processing and sensor control.

2. The distributed sensor as in claim 1, wherein said electrical signal generator drives said electro-optic amplitude of phase modulator that generates optical side bands with separations equal to the Brillouin frequency in said sensing optical fiber.

3. The distributed sensor as in claim 1, wherein said PID controller takes the output from said frequency discriminator as error signal to keep this signal at its possible minimum.

4. The distributed sensor as in claim 1, wherein a polarization scrambler minimizes polarization fluctuation induced sensor instability.

5. The distributed sensor as in claim 1, wherein one of said two DFB lasers works as a CW probe and the other works as a pulsed pump.

6. The distributed sensor as in claim 1, wherein said optical receiver converts optical signal into electric signal and a following Analog to Digital Converter digitalizes it for further signal processing by a computer.
